(19) United States
(12) Patent Application Publication
(10) Pub. No.: US 2013/0222540 A1
(43) Pub. Date: Aug. 29, 2013

(54) INFORMATION INTEGRATING DEVICE, INFORMATION DISPLAY DEVICE, INFORMATION RECORDING DEVICE, INFORMATION INTEGRATING METHOD, INFORMATION INTEGRATING PROGRAM, AND COMPUTER-READABLE RECORDING MEDIUM HAVING RECORDED THEREON INFORMATION INTEGRATING PROGRAM

(71) Applicants: Hideharu Tajima, Osaka-shi (JP); Hiroshi Kijima, Osaka-shi (JP)

(72) Inventors: Hideharu Tajima, Osaka-shi (JP); Hiroshi Kijima, Osaka-shi (JP)

(73) Assignee: SHARP KABUSHIKI KAISHA, Osaka-shi, Osaka (JP)

(21) Appl. No.: 13/881,454

(22) PCT Filed: Nov. 10, 2011
(86) PCT No.: PCT/JP2011/076012

§ 371 Date: Apr. 25, 2013

(30) Foreign Application Priority Data
Nov. 15, 2010 (JP) 2010-254929

(51) Int. Cl. H04N 13/02

(52) U.S. Cl. CPC H04N 13/026
USPC 348/43

(57) ABSTRACT

A receiver (101) that receives main information (2) including 2D video content and complementary information (3) for converting the 2D video content to 3D, and an integrating unit (102) that integrates the main information (2) and the complementary information (3), received by the receiver (101), as integrated information (4) by using the main information (2) and the complementary information (3) are provided. Accordingly, 3D video can be viewed without changing the broadcasting format of the current 2D broadcasting or without degrading the image quality.

### TECHNICAL FIELD

The present invention relates to an information integrating device or the like that makes it possible to view stereoscopic video (3D video) generated by converting 2-dimensional (D) video content to 3D.

### BACKGROUND ART

As stereoscopic video display devices (3D displays) for viewing stereoscopic video have been developed in recent years, various 3D video transmission systems have also been developed.

For example, PTL 1 discloses a transmission system that makes it possible to transmit 3D video utilizing a 2D broadcast transmission system by transmitting main video information as before and compressing complementary information necessary for 3D video display to minimum and sending the information using a frequency band gap.

Also, PTL 2 discloses a 3D video transmission system that realizes 3D broadcasting corresponding to a DFD system (Depth-Fused 3-D: 3D display system using no glasses) or the like by adding depth information to RGB information in the current broadcasting system.

### CITATION LIST

### Patent Literature

PTL 1: Japanese Unexamined Patent Application Publication No. 63-256091 (published on Oct. 24, 1988)
PTL 2: Japanese Unexamined Patent Application Publication No. 2004-274642 (published on Sep. 30, 2004)

### SUMMARY OF INVENTION

### Technical Problem

By the way, in the current broadcasting system, the TV broadcasting system is standardized for 2D video; it is thus difficult to broadcast 3D video while the current 2D video image quality is maintained.

For example, when 2D video is converted to 3D video while the image quality is kept, an information amount of about +30% is necessary. However, the transfer rate of the current broadcasting format (terrestrial digital broadcasting format) is 17 Mbps at maximum. The transfer rate of this broadcasting is about 15 Mbps, and data broadcasting is broadcast at 2 Mbps. Thus, 3D video at the current 2D video broadcasting level (image quality) cannot be broadcast unless the maximum transfer rate is increased.

Therefore, the technology described in PTL 1 and 2 and the like, which transfer 3D video by utilizing the current broadcasting format, has a problem that 3D video broadcasting at the current 2D video broadcasting level cannot be realized.

In view of the above-described problem of the background art, it is an object of the present invention to provide an information integrating device or the like that makes it possible to view 3D video without changing the current broadcasting format or without degrading the image quality.

### Solution to Problem

In order to solve the above-described problem, an information integrating device of the present invention includes a main information receiver that receives main information including two-dimensional video content; a complementary information receiver that receives complementary information for converting the two-dimensional video content to stereoscopic video; and an integrating unit that integrates the main information, received by the main information receiver, and the complementary information, received by the complementary information receiver, as stereoscopic video information by using the main information and the complementary information.

In order to solve the above-described problem, an information integrating method of the present invention is an information integrating method executed by an information integrating device that integrates main information including two-dimensional video content and complementary information for converting the two-dimensional video content to stereoscopic video as stereoscopic video information, including: a main information receiving step of receiving the main information; a complementary information receiving step of receiving the complementary information; and an integrating step of integrating the main information, received in the main information receiving step, and the complementary information, received in the complementary information receiving step, as stereoscopic video information by using the main information and the complementary information.

Here, of the main information and the complementary information, the main information at least including two-dimensional video content (hereinafter referred to as 2D video content) can be transmitted by using the current broadcasting format which transmits 2D video content.

Therefore, according to the above-described configuration or method, stereoscopic video information can be obtained by integrating the main information received by the main information receiver (main information receiving step) and the complementary information received by the complementary information receiver (complementary information receiving step). Thus, what needs to be transmitted to the information integrating device simply include the main information and the complementary information, and it is unnecessary to directly transmit the stereoscopic video information itself.

Accordingly, the transmission system of the current 2D broadcasting format can be used as it is.

Further, because the stereoscopic video information can be obtained by complementing the main information including the 2D video content with the complementary information, the stereoscopic video information becomes information capable of displaying stereoscopic video while keeping the image quality of the 2D video content. In short, using this stereoscopic video information, 3D video can be viewed with the same image quality as that in 2D broadcasting.

From the above description, 3D video can be viewed without changing the broadcasting format of the current 2D broadcasting or without degrading the image quality.

Here, examples of the “2D video content” include, besides moving images (including music, audio data, text data such as subtitles, and the like), still images such as frame-by-frame advancing images and the like.

Also, examples of the “complementary information” include pseudo 2D-3D conversion information for converting 2D video content to pseudo three-dimensional video (3D), left-eye video or right-eye video in the case where 2D video content serves as the right-eye video or the left-eye video, and the like.

That is, the “complementary information” for realizing 2D-3D conversion is not necessary the actual video data, and may be differential information with respect to the 2D video content (right-eye video or right-eye video). In the first place, the “complementary information” may not relate to video data and may only necessary be complementary information for realizing 2D-3D video conversion.

### Advantageous Effects of Invention

As described above, an information integrating device of the present invention includes a main information receiver that receives main information including two-dimensional video content; a complementary information receiver that receives complementary information for converting the two-dimensional video content to stereoscopic video; and an integrating unit that integrates the main information, received by the main information receiver, and the complementary information, received by the complementary information receiver, as stereoscopic video information by using the main information and the complementary information.

As described above, an information integrating method of the present invention is an information integrating method executed by an information integrating device that integrates main information including two-dimensional video content and complementary information for converting the two-dimensional video content to stereoscopic video as stereoscopic video information, including: a main information receiving step of receiving the main information; a complementary information receiving step of receiving the complementary information; and an integrating step of integrating the main information, received in the main information receiving step, and the complementary information, received in the complementary information receiving step, as stereoscopic video information by using the main information and the complementary information.

Therefore, there is an advantage that 3D video can be viewed without changing the broadcasting format of the current 2D broadcasting or without degrading the image quality.

Other objects, features, and excellent points of the present invention will be fully understood from the following description. Also, advantages of the present invention will become apparent from the following description with reference to the attached drawings.

### BRIEF DESCRIPTION OF DRAWINGS

FIG. 1 is a block diagram illustrating the configuration of a stereoscopic video integrating device according to an embodiment of the present invention.

FIG. 2 is a block diagram illustrating the configuration of a stereoscopic video display system with the above-described stereoscopic video integrating device.

FIG. 3 is a block diagram illustrating the configuration of a 3D display included in the above-described stereoscopic video display system.

FIG. 4 is a block diagram illustrating the configuration of 3D glasses included in the above-described stereoscopic video display system.

FIG. 5 is a block diagram illustrating the configuration of a stereoscopic video display system according to another embodiment of the present invention.

FIG. 6 is a block diagram illustrating the configuration of a stereoscopic video integrating device provided in the above-described stereoscopic video display system.

FIG. 7 is a block diagram illustrating the configuration of a stereoscopic video display system according to yet another embodiment of the present invention.

FIG. 8 is a block diagram illustrating the configuration of a stereoscopic video display system according to yet another embodiment of the present invention.

### DESCRIPTION OF EMBODIMENTS

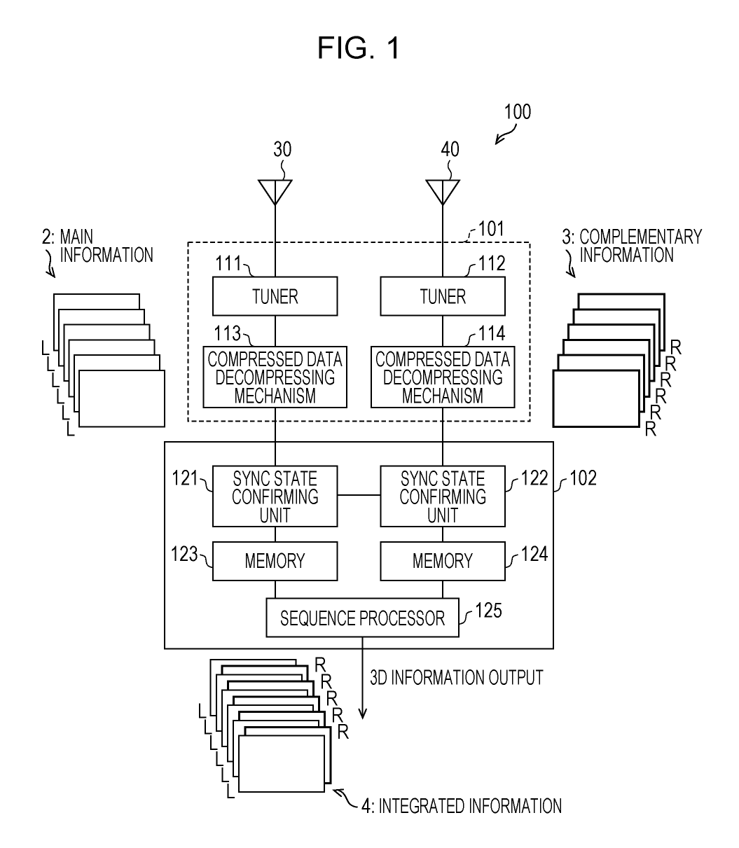

Embodiments of the present invention will be described with reference to FIGS. 1 to 8 as below. Although a description of a configuration other than that described in the following particular embodiments may be omitted as needed, when that configuration is described in another embodiment, the configuration is the same as that configuration. Also, to simplify the description, members with the same functions as those discussed in each of the embodiments may be given the same reference numerals, and descriptions thereof will be appropriately omitted.

### First Embodiment

(Configuration of Stereoscopic Video Display System 1001)

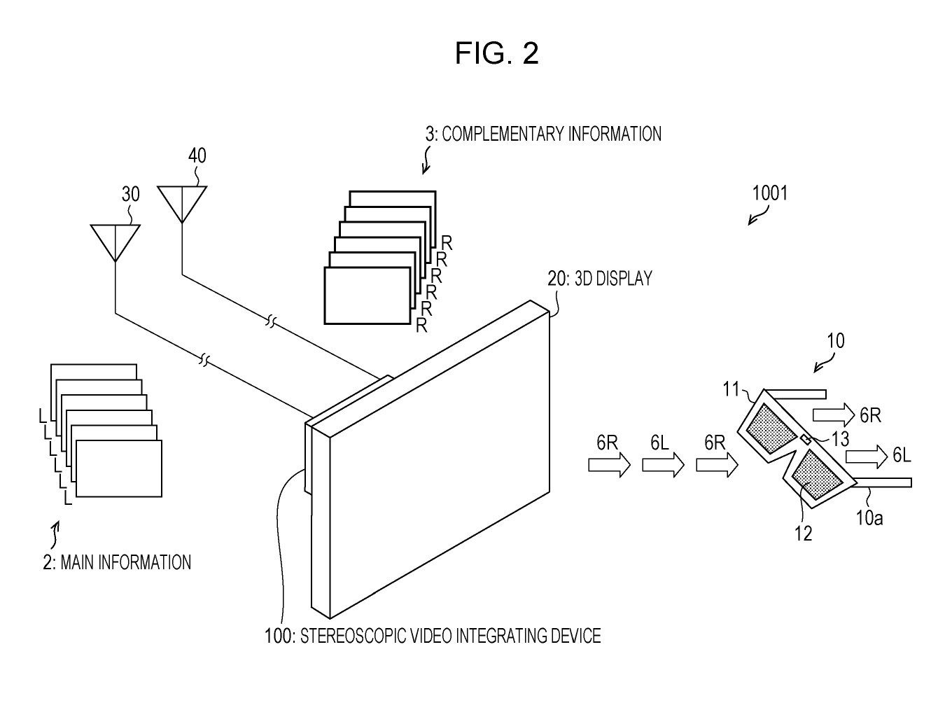

Firstly, the overall configuration of a stereoscopic video display system (information display device, information recording device) 1001 according to an embodiment of the present invention will be described on the basis of FIG. 2, and then the configuration of a stereoscopic video integrating device (information integrating device) 100 provided in the stereoscopic video display system 1001 will be described on the basis of FIG. 1.

FIG. 2 is a block diagram illustrating the configuration of the stereoscopic video display system 1001. As illustrated in FIG. 2, the stereoscopic video display system 1001 includes 3D glasses 10, a 3D display (information display device, information recording device) 20, and the stereoscopic video integrating device 100.

A first antenna 30 for receiving main information 2 at least including 2D video content (two-dimensional video content) and a second antenna 40 for receiving complementary information 3 for converting the main information 2 to stereoscopic video (3D) are connected to the stereoscopic video integrating device 100.

Also, the 2D video content included in the main information 2 includes multiple pieces of left-eye video information L (main frames), and the complementary information 3 includes multiple pieces of right-eye video information R (complementary frames).

Here, examples of the “2D video content” include, besides moving images (including music, audio data, text data such as subtitles, and the like), still images such as frame-by-frame advancing images and the like.

Examples of the data format of the “2D video content” include Flash (Web animation creating software sold by Macromedia) relating to video, JPEG (Joint Photographic Experts Group) systems relating to compression of still images, and MPEG (Moving Picture Experts Group) systems relating to compression of moving images.

Note that the MPEG systems are standards for compressing/expanding moving images and audio, which are proposed as the standard technology by ITU-T (International Telecommunication Union Telecommunication Standardization Sector) and ISO (International Organization for Standardization). The current MPEG systems include MPEG 1 used in media such as video CDs, MPEG 2 used in DVDs (Digital versatile discs) and broadcasting media, MPEG 4 for network distribution and mobile terminals, and the like.

Further, examples of the distribution method of the “2D video content” include distribution using wired or wireless communication, such as Bluetooth (registered trademark), Felica, PLC (power line communication), Wireless LAN (WLAN), IrDA (infrared wireless), IrSS (infrared wireless), TransferJet, WCDMA (communication network), and the like.

Also, examples of “broadcast content” included in the “2D video content” include broadcasting programs such as TV broadcasting by the NTSC (national television system committee) system, PAL (phase alternation by line) system, SECAM (sequential couleur a memoire system) system, HD-MAC (high definition-multiple analogue component) system, and ATV (advanced television) system, dual audio multiplex broadcasting, stereophonic audio multiplex broadcasting, satellite broadcasting using radio waves from a broadcasting satellite (BS) or communication satellite (CS), cable television (CATV), extended definition television (EDTV), high definition television (HDTV), MUSE system, 1 seg, 3 seg, terrestrial digital broadcasting, and the like.

Other examples of the “complementary information 3” include pseudo 2D-3D conversion information for converting 2D video content to pseudo 3D, left-eye video information L or right-eye video information R in the case where 2D video content serves as the right-eye video information R or the left-eye video information L, and the like.

That is, the “complementary information 3” for realizing 2D-3D conversion is not necessary the actual video data, and may be differential information with respect to the 2D video content (right-eye video information R or left-eye video information L). In the first place, the “complementary information 3” may not relate to video data and may only necessary be complementary information for realizing 2D-3D video conversion.

In the stereoscopic video display system 1001, the stereoscopic video integrating device 100 generates integrated information 4 (stereoscopic video information) by integrating the main information 2 received by the first antenna 30 and the complementary information 3 received by the second antenna 40, and outputs the stereoscopic video information as 3D video to the 3D display 20. The integrated information 4 is obtained by alternately arranging, on a frame-by-frame basis, multiple pieces of left-eye video information L and multiple pieces of right-eye video information R and synchronizing the left-eye video information L and the right-eye video information R.

The 3D display 20 alternately displays, on a frame-by-frame basis, left-eye video 6L (main frames) corresponding to the left-eye video information L and right-eye video 6R (complementary frames) corresponding to the right-eye video information R, which are output from the input integrated information 4.

The 3D glasses 10 are active shutter glasses. That is, the 3D glasses 10 show 3D video by utilizing the parallax of a viewer by alternately opening a right-eye shutter 11 and a left-eye shutter 12 corresponding to the right-eye video 6R and the left-eye video 6L alternately displayed on the 3D display 20.

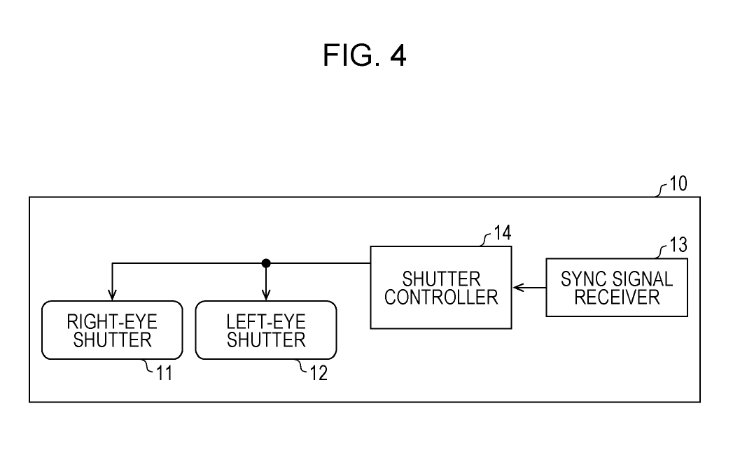

When the right-eye video 6R is displayed on the 3D display 20, control is performed to open the right-eye shutter 11 of the 3D glasses 10 and to close the left-eye shutter 12. When the left-eye video 6L is displayed on the 3D display 20, the left-eye shutter 12 of the 3D glasses 10 opens, and the right-eye shutter 11 closes. Synchronization of the shutter opening/closing at this time is performed by receiving, at a sync signal receiver 13 provided on the 3D glasses 10, a sync signal for shutter opening/closing sent from the 3D display 20. Also, the shutter opening/closing control is performed by a shutter controller 14 (FIG. 4) described later.

The 3D video display system described above is a time sequential system. However, the 3D video display system is not limited to this system. Other examples include a polarization system, a lenticular system, and a parallax barrier system.

In the polarization system, a polarizing element is stacked as a phase difference film on a display panel (such as a liquid crystal display) of the 3D display 20, and the left-eye video 6L and the right-eye video 6R are displayed with polarization orthogonal to each other on a line (horizontal scanning line)-by-line basis. Videos of lines with different polarization directions are separated by polarized glasses on a line-by-line basis to obtain stereoscopic video.

In the lenticular system, a lenticular lens, which is a special lens, is placed on pixels of a display panel of the 3D display 20, and different videos are displayed at different viewing angles. The lenticular lens is an array of numerous convex D-shaped lenses, each of which has a size corresponding to a few pixels. On the display panel, the left-eye video 6L and the right-eye video 6R are split on a pixel-by-pixel basis, and then the pixels are rearranged (rendered) on the 3D display 20. When this is viewed with both eyes, 3D video is viewed since the right eye and the left eye have different viewing angles. A characteristic of this system is that 3D video can be viewed with naked eyes without wearing special glasses.

Next, in the parallax barrier system, a barrier with an opening is placed in front of a display panel (such as a liquid crystal display) of the 3D display 20. Because both eyes have lines of sight that pass the opening at different angles, 3D video is obtained by utilizing a line-of-sight separation phenomenon based on this parallax. Also with this method, 3D video can be viewed with naked eyes without wearing special glasses.

(Configuration of Stereoscopic Video Integrating Device 100)

FIG. 1 is a block diagram illustrating the configuration of the stereoscopic video integrating device 100. The stereoscopic video integrating device 100 includes, as illustrated in FIG. 1, a receiver 101 that receives the main information 2 and the complementary information 3, and an integrating unit 102 that outputs the integrated information 4 serving as stereoscopic video information from the received main information 2 and complementary information 3.

The receiver 101 includes a tuner 111 connected to the first antenna 30, a tuner 112 connected to the second antenna 40, a compressed data decompressing mechanism 113 connected to the tuner 111, and a compressed data decompressing mechanism 114 connected to the tuner 112.

The tuner 111 connected to the first antenna 30, and the compressed data decompressing mechanism 113 constitute a main information receiver for receiving a TV broadcast (left-eye video information L) of 2D video content serving as the main information 2. The tuner 112 connected to the second antenna 40, and the compressed data decompressing mechanism 114 constitute a complementary information receiver for receiving complementary information (right-eye video information R) for converting 2D video content serving as the complementary information 3 to 3D.

That is, the tuner 111 receives the left-eye video information L, which is the main information 2, via the first antenna 30. Also, the tuner 112 receives the right-eye video information R, which is the complementary information 3, via the second antenna 40.

Note that the tuner 111 and the tuner 112 are separately provided. The tuner 112 is configured to receive the complementary information 3 from a channel different from a channel used for the tuner 111 to receive the main information 2.

Since information (left-eye video information L and right-eye video information R) received at the receiver 101 has been compressed in a certain format, the information is decompressed (expanded) by the compressed data decompressing mechanisms 113 and 114 at a subsequent stage, and then output to the integrating unit 102.

That is, the compressed data decompressing mechanism 113 outputs the left-eye video information L, which is decompressed in accordance with the compression format of the received main information 2, to a sync state confirming unit 121 of the integrating unit 102 at a subsequent stage. At the same time, the compressed data decompressing mechanism 114 outputs the right-eye video information R, which is decompressed in accordance with the compression format of the received complementary information 3, to a sync state confirming unit 122 of the integrating unit 102 at a subsequent stage.

The integrating unit 102 includes the sync state confirming unit 121 connected to the compressed data decompressing mechanism 113, the sync state confirming unit 122 connected to the compressed data decompressing mechanism 114, a memory 123 connected to the sync state confirming unit 121, a memory 124 connected to the sync state confirming unit 122, and a sequence processor 125 connected to the memory 123 and the memory 124.

The sync state confirming units 121 and 122 confirm sync information attached to pieces of information obtained by the sync state confirming units 121 and 122, confirm the order of sequence on the basis of the sync information, and temporarily store the left-eye video information L and the right-eye video information R in the memory 123 and the memory 124, respectively.

Examples of the “sync information” include (1) a sync signal for notifying the receiver side of a signal receiving timing for surely detecting transmitted information “bits”; (2) two signals indicating, when 3D video (left-eye video 6L or right-eye video 6R) is displayed on the 3D display 20, the timing to display a scanning line, and the timing to start displaying the next screen after displaying the scanning line up to the bottom end of the screen and then returning to the top of the screen. Alternatively, the sync information may include information such as the total number of frames constituting 2D video content, and the total number of complementary frames included in the complementary information.

Also, a “synchronous communications method” that provides, besides a channel for transmitting the main information 2, a channel for transmitting the complementary information 3, and that includes sync information in one of the main information 2 and the complementary information 3 and sends the information may be adopted as a sync information communicating method, as in this embodiment. Alternatively, a “non-synchronous communications method” that adds, for each set of signals transmitting the main information 2 or the complementary information 3 (e.g., for each frame), a sync signal of a particular pattern representing the start and end of a signal and that sends the information may be adopted.

Here, for example, as a method of specifying, by the sync state confirming unit 121, the order of sequence of the left-eye video information L to be temporarily recorded in the memory 123, the following is conceivable. That is, the total number of frames of the left-eye video information L is confirmed from the sync information, the left-eye video information L corresponding to the total number of frames is stored in the memory 123 in the order of reception, and the recording position of the first frame or the last frame of the left-eye video information L is specified. Accordingly, the order of sequence up to the first frame or the last frame of the left-eye video information L can be specified. The sequence processor 125 knows in which order the sequence processor 125 should read the left-eye video information L from the memory 123. The sequence of the right-eye video information R to be temporarily recorded in the memory 124 can be similarly specified. Note that reception of one frame can be realized by, for example, including information indicating the beginning and end of that frame in each frame.

The sequence processor 125 alternately arranges the left-eye video information L stored in the memory 123 and the right-eye video information R stored in the memory 124 on a frame-by-frame basis, from the first frame to the last frame, in accordance with the order of sequence of the left-eye video information L from the specified first frame to the specified last frame, and the order of sequence of the right-eye video information R from the specified first frame to the specified last frame, and outputs 3D video as the integrated information 4.

That is, in the sequence processor 125, synchronization between the input left-eye video information L and right-eye video information R is achieved on the basis of the temporary recording (storage in the memory 123 and the memory 124), and, when sync information (assuming that sync information is attached to data broadcasting as frame 1-R or the like) is attached, on the basis of the sync information. The left-eye video information L (main frames) and the right-eye video information R (complementary frames) are alternately arranged on a frame-by-frame basis, and the result is output as 3D video (stereoscopic video) to the 3D display 20.

As described above, the integrating unit 102 may perform time adjustment for alternately arranging, on a frame-by-frame basis, multiple pieces of left-eye video information L constituting 2D video content included in the main information 2 and multiple pieces of right-eye video information R that are included in the complementary information 3 and that individually correspond to the multiple pieces of left-eye video information L, thereby synchronizing the left-eye video information L and the right-eye video information R, which corresponds to the left-eye video information L.

At this time, it is necessary to perform time adjustment for alternately arranging, on a frame-by-frame basis, the pieces of left-eye video information L and the pieces of right-eye video information R corresponding to the pieces of left-eye video information L, by taking into consideration the timing to receive the main information 2 (left-eye video information L) by the tuner (main information receiver) 111, the timing to receive the complementary information 3 (right-eye video information R) by the tuner (complementary information receiver) 112, the transmission rates of the main information 2 and the complementary information 3, times involved in decompressing (expanding) the main information 2 and the complementary information 3 when the main information 2 and the complementary information 3 are compressed information, and the like.

Here, as described above, the integrating unit 102 may perform time adjustment for alternately arranging, on a frame-by-frame basis, the left-eye video information L and the right-eye video information R corresponding to the left-eye video information L by using the sync information. Accordingly, more detailed time adjustment, such as adjustment of minute time intervals between frames, can be performed using the sync information.

As described above, the integrating unit 102 may perform time adjustment for alternately arranging, on a frame-by-frame basis, the left-eye video information L and the right-eye video information R corresponding to the left-eye video information L by recording at least one of the left-eye video information L and the right-eye video information R corresponding to the left-eye video information L in the memory (temporary recording unit) 123 or 124.

Accordingly, the timing to input the left-eye video information L and the right-eye video information R corresponding to the left-eye video information L to the sequence processor 125 can be adjusted by temporarily recording at least one of the left-eye video information L and the right-eye video information R corresponding to the left-eye video information L in the memory 123 or 124. Thus, the above-described sync information is unnecessary.

Accordingly, processing using the sync information becomes unnecessary. Thus, it becomes unnecessary to provide a processor for performing such processing in the stereoscopic video integrating device 100, and the device can be simplified. Also, the amount of transmission of information can be saved for the amount of sync information.

(Configuration of 3D Display 20)

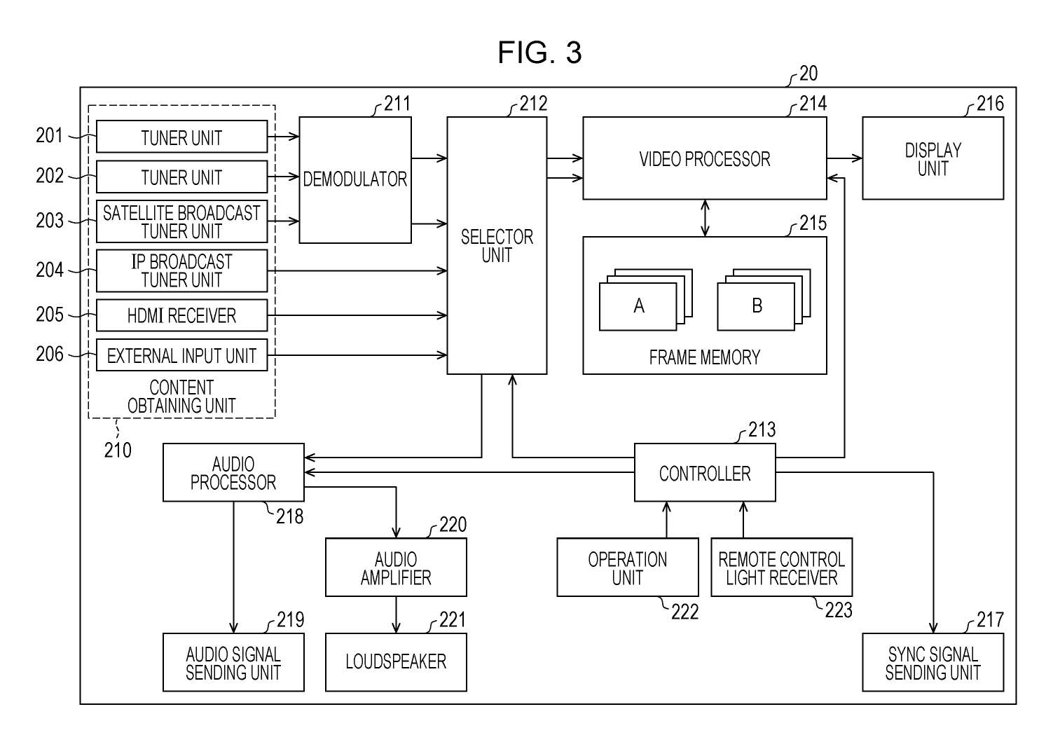

FIG. 3 is a block diagram illustrating the configuration of the 3D display 20. The 3D display 20 includes, as illustrated in FIG. 3, a content obtaining unit 210, a demodulator 211, a selector unit 212, a controller 213, a video processor (display controller, recording controller) 214, a frame memory (recording unit) 215, a display unit 216, a sync signal sending unit 217, an audio processor 218, an audio signal sending unit 219, an audio amplifier 220, a loudspeaker 221, an operation unit 222, and a remote control light receiver 223.

The content obtaining unit 210 is means for obtaining content data, such as video and audio supplied from the outside. The content obtaining unit 210 includes tuner units 201 and 202, a satellite broadcast tuner unit 203, an IP broadcast tuner unit 204, an HDMI receiver 205, and an external input unit 206. Note that HDMI is an acronym for High Definition Multimedia Interface.

The tuner units 201 and 202 obtain content of analog broadcast signals and terrestrial digital broadcast signals. The tuner units 201 and 202 supply video signals and audio signals of the obtained content to the demodulator 211.

The satellite broadcast tuner unit 203 obtains content of satellite broadcast signals, and supplies video signals and audio signals of the obtained content to the demodulator 211.

The IP broadcast tuner unit 204 obtains content from a device (such as a server device) connected via a network, and supplies video and audio of the obtained content to the selector unit 212. Note that the network is not particularly limited. For example, a network using telephone lines, LAN, or the like can be used.

The HDMI receiver 205 obtains content via an HDMI cable, and supplies video and audio of the obtained content to the selector unit 212.

The external input unit 206 obtains content supplied from an external device connected to the 3D display 20, and supplies video and audio of the obtained content to the selector unit 212. The external device may be an HDD (Hard Disk Drive), an external memory, a BD (Blu-ray (registered trademark) Disc) player, a DVD (Digital Versatile Disk) player, a CD (Compact Disc) player, a game machine, or the like.

Note that the above-described stereoscopic video integrating device 100 is connected to the above-described HDMI receiver 205. Accordingly, an operation performed with a remote controller or the like at the 3D display 20 side can be operatively associated with the stereoscopic video integrating device 100. This linking operation of the stereoscopic video integrating device 100 will be described later.

The demodulator 211 demodulates video signals and audio signals supplied from the tuner units 201 and 202 and the satellite broadcast tuner unit 203, and supplies the demodulated video and audio to the selector unit 212.

On the basis of an instruction from the controller 213, the selector unit 212 selects video and audio to be reproduced from among the supplied videos and audios, supplies the selected video to the video processor 214, and supplies the selected audio to the audio processor 218.

On the basis of a user instruction, the controller 213 determines, as a target to be reproduced, which video to display and which audio to output, from among videos and audios obtained by the content obtaining unit 210 described later, and gives an instruction to the selector unit 212 which video and audio are to be reproduced.

When different videos are selected as targets to be reproduced, the controller 213 supplies, to the video processor 214, a switching timing signal indicating the switching timing to sequentially display the different videos on the display unit 216.

Also, in order to enable the 3D glasses 10 to distinguish different videos (left-eye video 6L, right-eye video 6R) displayed on the display unit 216, the controller 213 instructs the sync signal sending unit 217 to send a shutter opening/closing sync signal (video distinguishing signal) synchronized with the timing to switch video displayed on the display unit 216.

Further, the controller 213 instructs the audio processor 218 whether to output audio from the audio signal sending unit 219 or the loudspeaker 221.

The controller 213 collectively controls the individual configurations included in the 3D display 20. Functions of the controller 213 can be realized by, for example, a CPU (central processing unit) reading a program stored in a storage device (not illustrated), which is realized by a ROM (read only memory) or the like, out to a RAM (random access memory) or the like (not illustrated) and executing the program.

The video processor 214 stores video supplied from the selector unit 212 in the frame memory 215 on a frame-by-frame basis. When different videos are supplied from the selector unit 212, the video processor 214 stores these videos in different regions of the frame memory 215. On the basis of a switching timing signal supplied from the controller 213, the video processor 214 reads these videos from the frame memory on a frame-by-frame basis, and supplies the videos to the display unit 216. The display unit 216 displays the videos on a frame-by-frame basis, which are supplied from the video processor 214.

On the basis of an instruction from the controller 213, the sync signal sending unit 217 sends a shutter opening/closing sync signal to the sync signal receiver 13 of the 3D glasses 10. Although the sync signal sending unit 217 adopts a configuration that sends a sync signal by performing wireless communication in this embodiment, the configuration is not limited to this case. A sync signal may be sent using a LAN or a communication cable such as HDMI. Wireless communication performed by the sync signal sending unit 217 can be realized by, for example, infrared communication or TransferJet.

On the basis of an instruction from the controller 213, the audio processor 218 supplies audio supplied from the selector unit 212 to the audio signal sending unit 219 or the audio amplifier 220.

The audio amplifier 220 supplies audio supplied from the audio processor 218 to the loudspeaker 221, and drives the loudspeaker 221 to output the supplied audio. Accordingly, the loudspeaker 221 outputs the audio supplied from the audio amplifier 220.

Also, the operation unit 222 accepts a user instruction given by operating the operation unit 222, and supplies the accepted user instruction to the controller 213. The remote control light receiver 223 obtains a user instruction given by operating a remote controller (not illustrated), and supplies the obtained user instruction to the controller 213. Note that the user instruction may be a selection instruction of selecting which video is to be displayed on the display unit 216, out of videos obtained by the content obtaining unit 210.

Note that, in the 3D display 20 in this embodiment, the video processor 214 illustrated in FIG. 3 corresponds to a recording controller, and the frame memory 215 corresponds to a recording unit. Thus, the 3D display 20 has a feature as an embodiment of an information recording device of the present invention. However, the information recording device of the present invention is not limited to an embodiment including the function of an information display device and the function of an information recording device, and may be a separate unit from the 3D display 20.

(Configuration of 3D Glasses 10)

FIG. 4 is a block diagram illustrating the configuration of the 3D glasses 10. The 3D glasses 10 are, as described above, active shutter glasses, and include the right-eye shutter 11, the left-eye shutter 12, the sync signal receiver 13, and the shutter controller 14.

The sync signal receiver 13 receives a shutter opening/closing sync signal sent from the sync signal sending unit 217 of the 3D display 20, and supplies the received sync signal to the shutter controller 14.

On the basis of the supplied sync signal, the shutter controller 14 alternately opens/closes the right-eye shutter 11 and the left-eye shutter 12. Specifically, for example, when the sync signal is a signal that takes two values, namely, high level (H level) and low level (L level), the shutter controller 14 opens the right-eye shutter 11 and closes the left-eye shutter 12 when the supplied sync signal is at H level, and performs control so that video passes only the right-eye shutter 11. In contrast, when the sync signal is at L level, the shutter controller 14 closes the right-eye shutter 11 and opens the left-eye shutter 12, thereby performing control so that video passes only the left-eye shutter 12.

That is, a user who is viewing the 3D display 20 can view the right-eye video 6R displayed on the 3D display 20 with the right eye when the right-eye shutter 11 of the 3D glasses 10 is open, and can view the left-eye video 6L displayed on the 3D display 20 with the left eye when the left-eye shutter 12 is open.

At this time, the user integrates the left and right videos based on the parallax of the left and right eyes and recognizes the integrated video as 3D video.

(Description of Basic Operation of Stereoscopic Video Display System 1001)

The basic operation of the stereoscopic video display system 1001 with the above-described configuration will be described below with reference to FIGS. 1 to 4.

Firstly, when the user adjusts a TV channel to a TV station performing 3D broadcasting by using a remote controller of the 3D display 20 or the like, the tuner 111 of the stereoscopic video integrating device 100 connected to the 3D display 20 operates in an associative manner and receives a 2D broadcast (2D video content) of the TV station selected by the user as main information 2.

In association with the receiving operation of the tuner 111, the tuner 112 operates in an associative manner so as to adjust to a channel that simultaneously broadcasts complementary information 3 specified by the above-described TV station, and the tuner 112 receives complementary information 3 for converting the 2D broadcast received by the tuner 111 to 3D.

The received signals are decompressed (expanded) by the compressed data decompressing mechanisms 113 and 114 in accordance with their compression formats to generate left-eye video information L and right-eye video information R, which are then input to the integrating unit 102.

With the sync state confirming units 121 and 122, the integrating unit 102 checks the sync state between the left-eye video information L and the right-eye video information R on the basis of distributed sync information attached to at least one of the main information 2 and the complementary information 3, and, from the sync information, records video information to be delayed in the memory 123 or 124 so as to synchronize the left-eye video 6L and the right-eye video 6R. After synchronization is achieved, the sequence processor 125 arranges the left-eye video 6L and the right-eye video 6R so as to be alternately arranged, and outputs the arranged left-eye video 6L and the right-eye video 6R as 3D video to the display unit 216 via the HDMI receiver 205 of the 3D display 20.

Here, when synchronization is achieved so that the left-eye video information L and the right-eye video information R are alternately arranged on a frame-by-frame basis, the left-eye video 6L obtained from the left-eye video information L and the right-eye video 6R obtained from the right-eye video information R are alternately displayed on the 3D display 20 on a frame-by-frame basis. Using the above-described 3D glasses 10, the user views the right-eye video 6R only with the right eye when the right-eye video 6R is displayed, and views the left-eye video 6L only with the left eye when the left-eye video 6L is displayed, thereby recognizing the video as stereoscopic video.

Note that, in the integrating unit 102, on the basis of distributed sync information attached to at least one of the main information 2 and the complementary information 3, the main information 2 and the complementary information 3 are synchronized, and the main information 2 and the complementary information 3 are arranged and integrated as integrated information 4. However, the manner of achieving synchronization is not limited to this case.

For example, at a timing at which the left-eye video information L and the right-eye video information R are input to the integrating unit 102, the left-eye video information L included in the main information 2 and the right-eye video information R included in the complementary information 3 may be synchronized, and the left-eye video information L and the right-eye video information R may be alternately arranged on a frame-by-frame basis and integrated as integrated information 4.

In this case, it is unnecessary to attach sync information to the main information 2 and the complementary information 3 and distribute the sync information. Thus, it becomes unnecessary to additionally provide a circuit or the like for performing processing using sync information, and, as a result, the circuit configuration of the device can be simplified.

As in this embodiment, when the complementary information 3 is distributed as well as the main information 2 in TV broadcasting, a sync signal for synchronizing the main information 2 and the complementary information 3 can be recorded using a region for data broadcasting. Thus, when a broadcasting station sends the main information 2 and the complementary information 3, detailed synchronization becomes unnecessary.

In the first embodiment, as described above, the example in which the complementary information 3 is transmitted in the same transmission format (format in which the complementary information 3 is transmitted on TV broadcasting waves) as the main information 2 has been described. However, transmission of the complementary information 3 is not necessary to be in the same transmission format as the main information 2, and the complementary information 3 may be transmitted via the Internet. In the following embodiment, an example in which transmission of the complementary information 3 is performed via the Internet will be described.

### Second Embodiment

(Configuration of Stereoscopic Video Display System 1002)

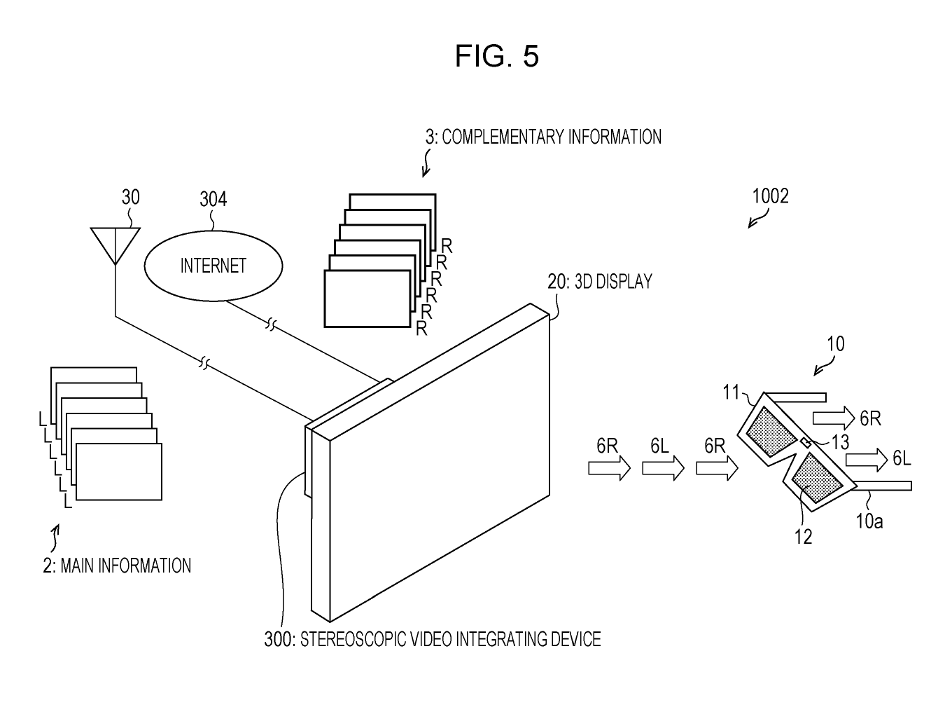

FIG. 5 is a block diagram illustrating the configuration of a stereoscopic video display system (information display device, information recording device) 1002 according to this embodiment.

As illustrated in FIG. 5, the stereoscopic video display system 1002 is different from the stereoscopic video display system 1001 in the above-described first embodiment in the point that the stereoscopic video display system 1002 has a stereoscopic video integrating device 300 instead of the stereoscopic video integrating device 100. Because the other elements are not different between the stereoscopic video display system 1002 and the stereoscopic video display system 1001, detailed descriptions thereof will be omitted.

(Configuration of Stereoscopic Video Integrating Device 300)

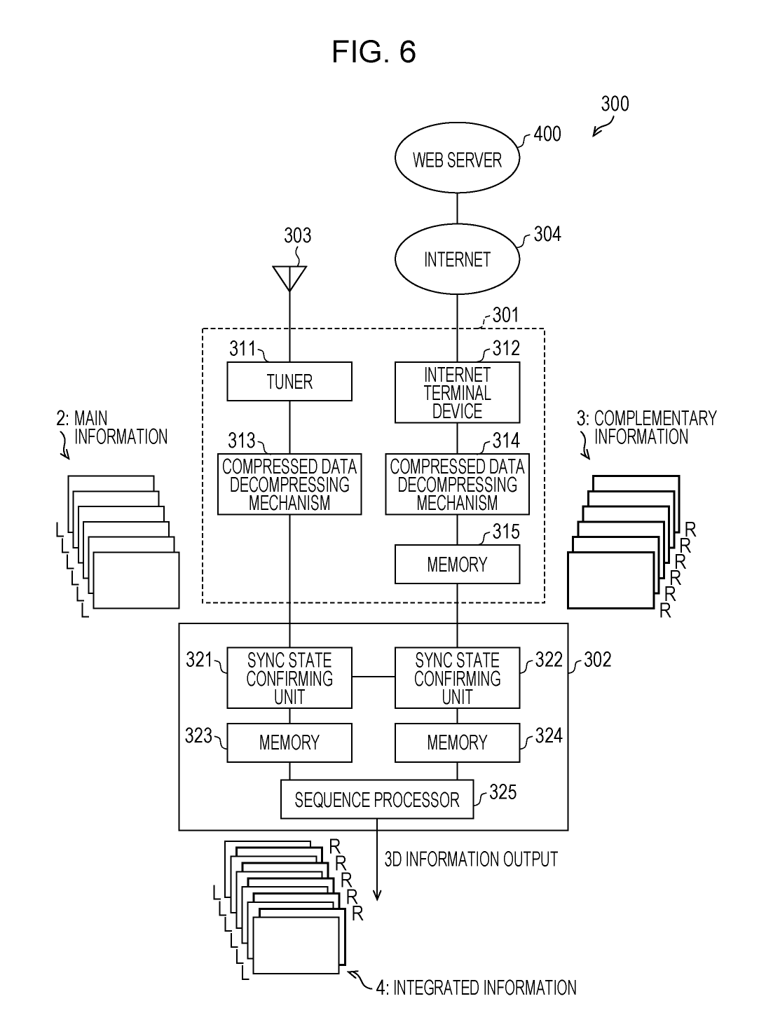

FIG. 6 is a block diagram illustrating the configuration of the stereoscopic video integrating device 300. The stereoscopic video integrating device 300 includes, as illustrated in FIG. 6, a receiver (main information receiver, complementary information receiver) 301 that receives main information 2 and complementary information 3, and an integrating unit 302 that outputs integrated information 4 serving as stereoscopic video information from the received main information 2 and complementary information 3.

The receiver 301 includes a tuner (main information receiver) 311 connected to a first antenna 303, an Internet terminal device (complementary information receiver) 312 connected to a web server 400 via the Internet 304, a compressed data decompressing mechanism 313, a compressed data decompressing mechanism 314, and a memory (temporary recording unit) 315.

The tuner 311 connected to the first antenna 303, and the compressed data decompressing mechanism 313 constitute a main information receiver for receiving a TV broadcast (left-eye video information L) of 2D video content serving as the main information 2. This point is the same as the stereoscopic video integrating device 100 in the above-described first embodiment. What is different is the configuration of a complementary information receiver for obtaining the complementary information 3.

That is, the complementary information receiver includes the Internet terminal device 312 connected to the web server 400 via the Internet 304, the compressed data decompressing mechanism 314, and the memory 315.

In the receiver 301 with the above-described configuration, as in the above-described first embodiment, the tuner 311 receives, as content, left-eye video information L which is the main information 2 via the first antenna 303.

In contrast, in the complementary information receiver, right-eye video information R which is the complementary information 3 is received by the Internet terminal device 312 via the Internet, unlike in the above-described first embodiment.

Since information (left-eye video information L and right-eye video information R) received at the receiver 301 has been compressed in a certain format, the information is decompressed (expanded) by the compressed data decompressing mechanisms 313 and 314 at a subsequent stage. After that, the compressed data decompressing mechanism 313 on the main information 2 side outputs the decompressed information as it is to the integrating unit 302, and the compressed data decompressing mechanism 314 on the complementary information 3 side temporarily stores the decompressed information in the memory 315, and then outputs the information to the integrating unit 302 at a certain timing.

That is, the compressed data decompressing mechanism 313 outputs the left-eye video information L, which is decompressed in accordance with the compression format of the received main information 2, to a sync state confirming unit 321 of the integrating unit 302 at a subsequent stage.

At the same time, the compressed data decompressing mechanism 314 temporarily stores the right-eye video information R, which is decompressed in accordance with the compression format of the received complementary information 3, in the memory 315, and outputs the information to a sync state confirming unit 322 of the integrating unit 302 at a subsequent stage.

As described above, the complementary information 3 is temporarily stored in the memory 315 in order to avoid the following circumstances.

That is, when the complementary information 3 is distributed via the Internet, if the complementary information receiver records the complementary information 3 received via the Internet in the memory 315 before the broadcast, the circumstances in which Internet connection becomes congested and it becomes too late for the broadcast can be avoided.

The integrating unit 302 includes the sync state confirming unit 321 connected to the compressed data decompressing mechanism 313, the sync state confirming unit 322 connected via the memory 315 to the compressed data decompressing mechanism 314, a memory 323 connected to the sync state confirming unit 321, a memory 324 connected to the sync state confirming unit 322, and a sequence processor 325 connected to the memory 323 and the memory 324.

Since the integrating unit 302 has the same configuration as the integrating unit 102 of the stereoscopic video integrating device 100 in the above-described first embodiment, details thereof will be omitted.

In the sequence processor 325, synchronization between the input left-eye video information L and right-eye video information R is achieved on the basis of the temporary recording (storage in the memory 323 and the memory 324), and, when sync information (assuming that sync information is attached to data broadcasting as frame 1-R or the like) is attached, on the basis of the sync information. The left-eye video information L (main frames) and the right-eye video information R (complementary frames) are alternately arranged on a frame-by-frame basis to generate integrated information 4, and the integrated information 4 is output as 3D video (stereoscopic video information) to the 3D display 20.

As in the stereoscopic video display system 1002 with the above-described configuration, means for obtaining the complementary information 3 has the same or similar advantages as in the above-described first embodiment by utilizing distribution from the web server 400 via the Internet 304, instead of using 2D broadcasting waves.

That is, even with the stereoscopic video integrating device 300 with the above-described configuration, 3D video can be viewed without changing the current broadcasting format or without degrading the image quality.

Also, obtaining of the complementary information 3 may be performed via a cable that sends television signals in CATV, instead of via the Internet. In this case, the Internet terminal device 312 of the stereoscopic video integrating device 300 is simply replaced by a set-top box for CATV.

As described above, according to the stereoscopic video integrating devices 100 and 300 of the first and second embodiments, because the receivers 101 and 301 for receiving main information and complementary information and the integrating units 102 and 302 are provided in both the stereoscopic video integrating devices 100 and 300, 3D video in a state where the current 2D image quality is maintained can be viewed by broadcasting the main information 2 (main broadcast) in a normal 2D broadcasting format and sending the complementary information 3 via a different channel or the Internet. Therefore, the TV station's risk is reduced, and hence, there is an advantage that the viewer can easily obtain 3D video.

Also, the examples in which the stereoscopic video integrating devices 100 and 300 described in the first and second embodiments include the receivers 101 and 301 directly connected to the antennas and the integrating units 102 and 302 have been described. Alternatively, the receivers 101 and 301 may be included in the 3D display 20, and the integrating units 102 and 302 may be externally attached to the 3D display 20.

In the following third embodiment, an example in which the receiver 101 of the stereoscopic video integrating device 100 of the above-described first embodiment is provided in the 3D display 20 will be described.

### Third Embodiment

(Configuration of Stereoscopic Video Display System 1003)

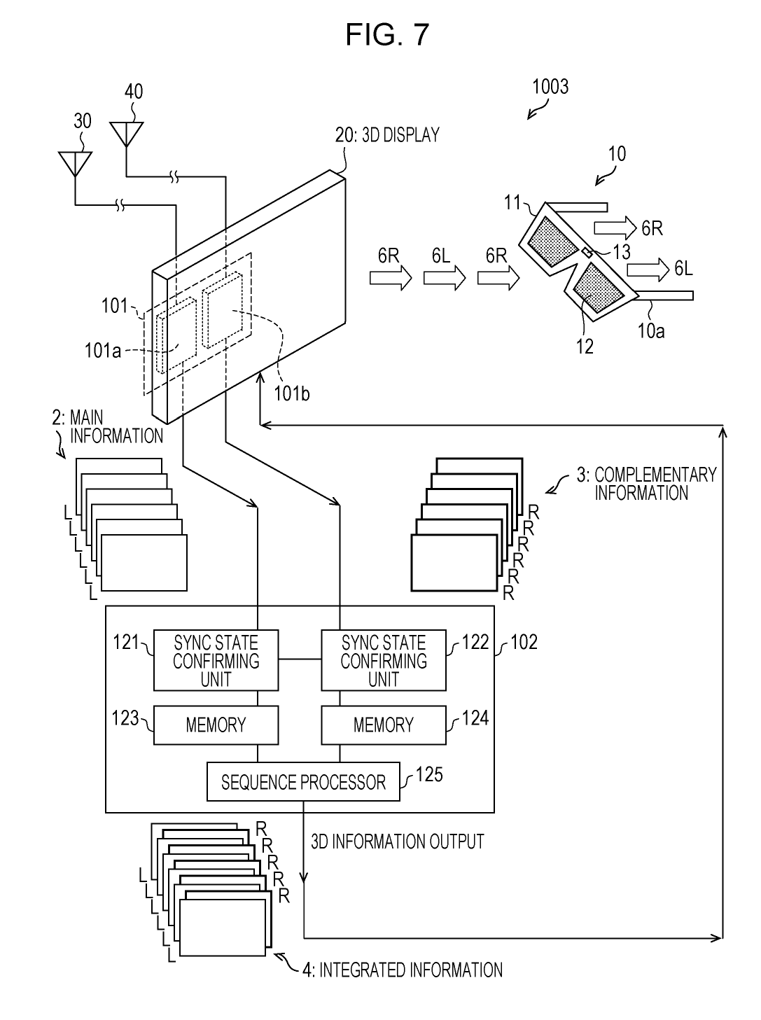

FIG. 7 is a block diagram illustrating the configuration of a stereoscopic video display system (information display device, information recording device) 1003 according to this embodiment. As illustrated in FIG. 7, the stereoscopic video display system 1003 has substantially the same configuration as the stereoscopic video display system 1001 illustrated in FIG. 2 in the above-described first embodiment, and the stereoscopic video display system 1003 is different from the stereoscopic video display system 1001 in the point that the receiver 101 in the stereoscopic video integrating device 100 is included in the 3D display 20.

The receiver (main information receiver, complementary information receiver) 101 includes a first receiver (main information receiver) 101a connected to the first antenna 30, and a second receiver (complementary information receiver) 101b connected to the second antenna 40.

The first receiver 101a constitutes a main information input unit including the tuner 111 and the compressed data decompressing mechanism 113 (not illustrated).

The second receiver 101b constitutes a complementary information input unit including the tuner 112 and the compressed data decompressing mechanism 114 (not illustrated).

Note that, as described above, when the receiver 101 is included in the 3D display 20, only the tuners 111 and 112 may be included in the 3D display 20, and the compressed data decompressing mechanisms 113 and 114 may be provided on the integrating unit 102 side.

Also, tuners originally included in the 3D display 20 may be used as the above-described tuners 111 and 112.

Even in the stereoscopic video display system 1003 with the above-described configuration, as in the stereoscopic video display system 1001 described in the other embodiment, left-eye video information L included in main information 2 received by the receiver 101 and right-eye video information R included in complementary information 3 are integrated by the integrating unit 104 to generate integrated information 4, and the integrated information 4 is output as 3D video to the 3D display 20.

The stereoscopic video display system 1003 with the above-described configuration has the same or similar advantages as in the first and second embodiments. That is, 3D video can be viewed without changing the current broadcasting format or without degrading the image quality.

In the first to third embodiments as described above, the examples in which the frame sequential 3D display 20 and the active shutter 3D glasses 10 are used are described as the 3D display system. However, the 3D display system is not limited to this system. Alternatively, a shutter may be provided on the 3D display 20 side, instead of the 3D glasses 10 side.

In the following fourth embodiment, an example of the 3D display system in which a shutter for switching between the left and right videos is provided on the 3D display side will be described.

### Fourth Embodiment

(Configuration of Stereoscopic Video Display System 1004)

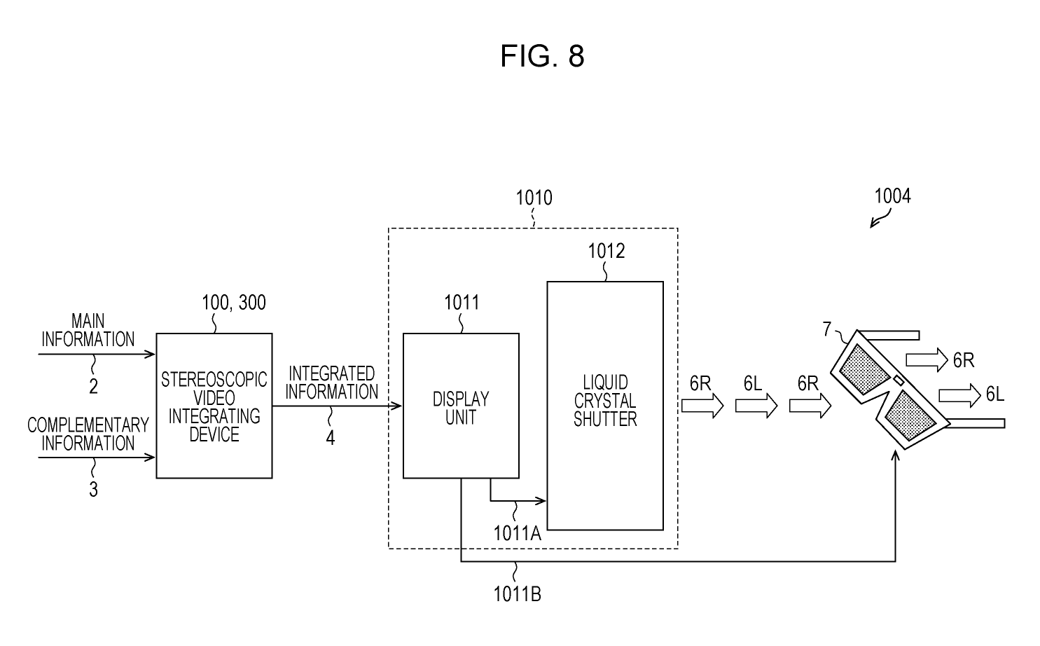

FIG. 8 is a block diagram illustrating the configuration of a stereoscopic video display system 1004 according to this embodiment. The stereoscopic video display system (information display device, information recording device) 1004 includes, as illustrated in FIG. 8, the stereoscopic video integrating device 100 or the stereoscopic video integrating device 300, a 3D display (information display device) 1010, and polarized glasses 7. The stereoscopic video integrating devices 100 and 300 are stereoscopic video integrating devices (information integrating devices) described in the first and second embodiments, respectively.

The 3D display 1010 is constituted of a display unit 1011 and a liquid crystal shutter 1012. The display unit 1011 and the liquid crystal shutter 1012 are connected by a line 1011A, and the display unit 1011 and the polarized glasses 7 are connected by a line 1011B.

Stereoscopic video information serving as integrated information 4 generated by the stereoscopic video integrating device 100 or 300 is input to the display unit 1011, and the display unit 1011 is configured to display 3D video. Note that the display unit 1011 is constituted of a TV, a projector, or the like.

The liquid crystal shutter 1012 is constituted of liquid crystal or the like and is configured to switch between two transmission deflection light beams.

The polarized glasses 7 are constituted of left and right liquid crystal shutters (or deflection plates different for the left and right) for viewing left-eye video information L and right-eye video information R including frames in a certain order via the liquid crystal shutter 1012.

Therefore, in the stereoscopic video display system 1004, using the human eye parallax, pieces of video information of left-eye video 6L and right-eye video 6R are projected to the left and right, and the polarized glasses 7 enable the viewer to view the video information as 3D video.

Also, as illustrated in FIG. 8, the liquid crystal shutter 1012, which is constituted of liquid crystal or the like and which is capable of switching between two transmission deflection light beams, is controlled to, for example, vertically deflect the transmitted right-eye video 6R and to horizontally deflect the left-eye video 6L, thereby changing the angle of deflection of light on a field-by-field basis.

In this case, the polarized glasses 7 are only necessary to include deflection plates different for the left and right (vertical deflection and horizontal deflection) that are attached to each other. The line 1011B for supplying, from the display unit 1011, a field sync signal corresponding to the timing to control the liquid crystal shutter 1012 by the display unit 1011 via the line 1011A to the polarized glasses 7 becomes unnecessary.

In contrast, when the liquid crystal shutter 1012 is not used, it is necessary to provide a liquid crystal shutter on the polarized glasses 7, and the line 1011B for a field sync signal becomes necessary.

As in the stereoscopic video display system 1004 according to this embodiment, even when the 3D display 1010 using another system as the 3D display system is used, the same or similar advantages as those in the first to third embodiments can be achieved.

### CONCLUSION

As described above, the information integrating device of the present invention is not limited to the stereoscopic video integrating devices described in the first to fourth embodiments, and the information integrating device of the present invention can have any configuration as long as the device at least has the following configuration.

(1) As a main information input unit capable of obtaining a TV broadcast (left-eye video information L) of 2D video content, a tuner with a terminal connectable to an antenna is provided.

(2) As a complementary information input unit capable of obtaining complementary information (right-eye video information R) for converting the 2D video content to 3D, another tuner for obtaining information from a channel different from the above is provided.

(3) An integrating unit is provided, which achieves synchronization between the input left-eye video information L and right-eye video information R on the basis of temporary recording, and, when a sync signal (assuming that a sync signal accompanies a data broadcasting unit as frame 1-R or the like) is attached, on the basis of the sync signal, and which alternately arranges main frames and complementary frames on a frame-by-frame basis and outputs the result.

Further, the main information 2 described in the above-described first to fourth embodiments may be 2D video content (for example, left-eye video information L), which is not limited to distribution via TV broadcasting waves, and which may be distribution of CATV via cable, or distribution via an external network such as the Internet.

Also, the complementary information 3 may be information necessary for converting 2D video content (such as right-eye video information R) or the main information 2 to 3D, which is not limited to distribution via TV broadcasting waves, and which may be distribution of CATV via cable, or distribution via an external network such as the Internet.

Also, a method of attaching a sync signal for synchronizing the main information 2 and the complementary information 3 may be a method of attaching data such as “frame 1 left” on a frame-by-frame basis in a data broadcasting region of terrestrial digital broadcasting, or a method of recording a sync signal in a format to be actually displayed in the corner of a screen (as in a time signal).

Although examples of the 3D display 20 and the 3D display 1010 in which the viewer cannot view 3D video broadcasting unless the viewer uses the 3D glasses 10 or the polarized glasses 7 have been described in the above-described first to fourth embodiments, the first to fourth embodiments are not limited to these examples. The invention of the present application is applicable to examples where a 3D display without using the 3D glasses 10 or the polarized glasses 7 is used.

In this case, for example, it is only necessary to further provide, for example, in the integrating unit 102, a video creating unit that automatically creates multi-viewpoint video information on the basis of the main information 2 and the complementary information 3.

Note that the technology disclosed in PTL 1 described above is a 3D video transmission method of performing both 2D broadcasting and 3D broadcasting by transmitting a main video signal (similar to main information) as before, and compressing a sub-video signal (similar to complementary information) to minimum and sending the signals using a frequency band gap. Also, the technology disclosed in PTL 2 described above is a 3D video transmission method that realizes 3D broadcasting which handles DFD (3D display system without using glasses) or the like in the current broadcasting system, which is a transmission method that realizes 3D broadcasting by adding depth information to RGB information.

However, the technology in these documents has difficulty in performing 3D broadcasting at full HD (full high definition) while adapting to the current broadcasting system. Further, these documents lack description of a specific configuration necessary for actually receiving information. In contrast, the information integrating device of the present invention performs, by adopting the above-described configuration, both 2D broadcasting and 3D broadcasting without changing the current broadcasting format, which is thus capable of performing 3D broadcasting without degrading the image quality. There is an advantage that the user can easily obtain stereoscopic video of high image quality.

Finally, the individual blocks of the stereoscopic video integrating devices 100 and 300, particularly the receivers 101 and 301 and the integrating units 102 and 302, may be realized in terms of hardware by using logic circuits formed on an integrated circuit (IC chip), or may be realized in terms of software using a CPU (Central Processing Unit).

In the latter case, the stereoscopic video integrating devices 100 and 300 each include a CPU (Central Processing Unit) that executes commands of a program for realizing the individual functions, a ROM (Read Only Memory) that stores the program, a RAM (Random Access Memory) that expands the program, a storage device (recording medium) such as a memory that stores the program and various types of data, and the like.

An object of the present invention can be achieved by supplying a computer-readable recording medium having recorded thereon program code (executable program, intermediate code program, or source program) of a control program (information integrating program or the like) of the stereoscopic video integrating devices 100 and 300, which is software for realizing the above-described functions, to the stereoscopic video integrating devices 100 and 300, and reading and executing the program code recorded on the recording medium by using a computer (or CPU or MPU (Micro Processor Unit)) of the stereoscopic video integrating devices 100 and 300.

As the recording medium, for example, tapes such as magnetic tapes and a cassette tape, disks including magnetic disks such as floppy (registered trademark) disks and hard disks and optical disks such as CD-ROM, MO, MD, DVD, and CD-R, cards such as IC cards (including memory cards)/optical cards, semiconductor memories such as mask ROM, EPROM, EEPROM, and flash ROM, logic circuits such as PLD (Programmable logic device) and FPGA (Field Programmable Gate Array), or the like can be used.

Alternatively, the stereoscopic video integrating devices 100 and 300 may be configured to be connectable to a communication network, and the program code may be supplied via the communication network.

The communication network is only necessary to be capable of transmitting the program code and is not particularly limited. For example, the Internet, an intranet, extranet, LAN, ISDN, VAN, CATV communication network, virtual private network, telephone network, mobile communication network, satellite communication network, or the like can be used.

Also, a transmission medium constituting the communication network is only necessary to be a medium capable of transmitting the program code, and is not limited to a medium with a particular configuration or of a particular type. For example, wired transmission media such as IEEE 1394, USB, power-line carriers, cable TV lines, telephone lines, and ADSL (Asymmetric Digital Subscriber Line) lines, or wireless transmission media such as infrared rays such as IrDA and a remote controller, TransferJet, Bluetooth (registered trademark), IEEE 802.11 wireless, HDR (High Data Rate), NFC (Near Field Communication), DLNA (Digital Living Network Alliance), mobile phone network, satellite links, and terrestrial digital networks can be used.

Note that the present invention can be realized as an encoded computer program in a computer-readable medium, in which, when the information integrating device has the readable medium and when the computer program is executed by a computer, the computer program realizes functions of the individual means of the information integrating device.

Also, the present invention can be represented as follows.

That is, the information integrating device of the present invention may perform time adjustment for alternately arranging, on a frame-by-frame basis, main frames constituting two-dimensional video content included in the main information and complementary frames that are included in the complementary information and that individually correspond to the main frames, thereby synchronizing the main frames and the complementary frames, which correspond to the main frames.

According to the above-described configuration, the integrating unit synchronizes the main frames and the complementary frames, which correspond to the main frames. More specifically, synchronization is achieved by alternately arranging, on a frame-by-frame basis, the main frames constituting 2D video content and the complementary frames corresponding to the main frames.

At this time, it is necessary to perform time adjustment for alternately arranging, on a frame-by-frame basis, the main frames and the complementary frames corresponding to the main frames, by taking into consideration the timing to receive the main information (main frames) by the main information receiver, the timing to receive the complementary information (complementary frames) by the complementary information receiver, the transmission rates of the main information and the complementary information, times involved in decompressing (expanding) the main information and the complementary information when the main information and the complementary information are compressed information, and the like. Thus, according to the above-described configuration, synchronization between the main frames and the complementary frames, which correspond to the main frames, can be appropriately achieved by performing the above time adjustment.

Also, in the information integrating device of the present invention, at least one of the main information and the complementary information includes sync information for synchronizing the main frames and the complementary frames, which correspond to the main frames, and the integrating unit may perform time adjustment for alternately arranging the main frames and the complementary frames, which correspond to the main frames, on a frame-by-frame basis by using the sync information.

According to the above-described configuration, more detailed time adjustment, such as adjustment of minute time intervals between frames, can be performed using the sync information.

Examples of the sync information include a sync signal sent from the sender side to the receiver side for reporting the timing to receive 2D video content when the 2D video content is transmitted, a signal indicating the timing to display a scanning line when stereoscopic video (main frame or complementary frame) is displayed on a certain display screen, and a signal indicating the timing to start displaying the next screen after displaying the scanning line up to the bottom end of the screen and then returning to the top of the screen.

Also, in the information integrating device of the present invention, the integrating unit may perform time adjustment for alternately arranging, on a frame-by-frame basis, the main frames and the complementary frames, which correspond to the main frames, by recording at least one of the main frames and the complementary frames, which correspond to the main frames, in a certain temporary recording unit.

According to the above-described configuration, by temporarily recording at least one of main information (main frames) and complementary information (complementary frames) corresponding to the main information in a certain temporary recording unit, the timing to input the main frames and the complementary frames, which correspond to the main frames, to the integrating unit can be adjusted. Therefore, the above-described sync information is unnecessary.

Accordingly, processing using the sync information becomes unnecessary. Thus, it becomes unnecessary to provide a processor for performing such processing in the information integrating device, and the device can be simplified. Also, the amount of transmission of information can be saved for the amount of sync information.

Also, the display control device of the present invention may include a display controller that performs processing to display stereoscopic video information integrated by the above-described information integrating device.

According to the above-described configuration, the display control device displays stereoscopic video information integrated by using the above-described information integrating device. It thus becomes possible to view 3D video without changing the broadcasting format of the current 2D broadcasting or without degrading the image quality.

Also, the information recording device of the present invention may include a recording controller that performs processing to record stereoscopic video information, integrated by the above-described information integrating device, in a certain recording unit.

According to the above-described configuration, the information recording device records stereoscopic video information, integrated by using the above-described information integrating device, in a certain recording unit. It thus becomes possible to quickly view desired stereoscopic video in accordance with the user's convenience.

Processes performed by the units of the information integrating device and steps of an information integrating method may be realized using a computer. In this case, an information integrating program for realizing, with a computer, the information integrating device and information integrating method by causing the computer to execute processes performed by the units or steps, and a computer-readable recording medium having recorded thereon the information integrating program also fall within the scope of the present invention.

(Appendix)

The present invention is not limited to the above-described embodiments, and various changes can be made within the scope of the claims. An embodiment achieved by appropriately combining technical means disclosed in different embodiments is also included in the technical scope of the present invention.

### INDUSTRIAL APPLICABILITY

The present invention is applicable to a receiving device of the current 2D broadcast or the current 2D video content distributed via the Internet, an information display device including the receiving device, an information recording device including the receiving device, or the like.

### REFERENCE SIGNS LIST

2 main information
3 complementary information
4 integrated information (stereoscopic video information)
6L left-eye video (main frames)
6R right-eye video (complementary frames)
20 3D display (information display device, information recording device)
100 stereoscopic video integrating device (information integrating device)
101 receiver (main information receiver, complementary information receiver)
101a first receiver (main information receiver)
101b second receiver (complementary information receiver)
102 integrating unit
111 tuner (main information receiver)
112 tuner (complementary information receiver)
123 memory (temporary recording unit)
124 memory (temporary recording unit)
214 video processor (display controller, recording controller)
215 frame memory (recording unit)
300 stereoscopic video integrating device (information integrating device)
301 receiver (main information receiver, complementary information receiver)
302 integrating unit
311 tuner (main information receiver)
312 Internet terminal device (complementary information receiver)
315 memory (temporary recording unit)
323 memory (temporary recording unit)
324 memory (temporary recording unit)
1001 stereoscopic video display system (information display device, information recording device)
1002 stereoscopic video display system (information display device, information recording device)
1003 stereoscopic video display system (information display device, information recording device)
1004 stereoscopic video display system (information display device, information recording device)
1010 3D display (information display device)
L left-eye video information (main frames)
6L left-eye video (main frames)
R right-eye video information (complementary frames)
6R right-eye video (complementary frames)

1. An information integrating device comprising:
a main information receiver that receives main information including two-dimensional video content;
a complementary information receiver that receives complementary information for converting the two-dimensional video content to stereoscopic video; and
an integrating unit that integrates the main information, received by the main information receiver, and the complementary information, received by the complementary information receiver, as stereoscopic video information by using the main information and the complementary information.

2. The information integrating device according to claim 1,
wherein the integrating unit performs time adjustment for alternately arranging, on a frame-by-frame basis, a plurality of main frames constituting the two-dimensional video content included in the main information and a plurality of complementary frames that are included in the complementary information and that individually correspond to the plurality of main frames,
thereby synchronizing the main frames and the complementary frames, which correspond to the main frames.

3. The information integrating device according to claim 2,
wherein at least one of the main information and the complementary information includes sync information for synchronizing the main frames and the complementary frames, which correspond to the main frames, and
wherein the integrating unit performs time adjustment for alternately arranging, on a frame-by-frame basis, the main frames and the complementary frames, which correspond to the main frames, by using the sync information.

4. The information integrating device according to claim 2,
wherein the integrating unit performs time adjustment for alternately arranging, on a frame-by-frame basis, the main frames and the complementary frames, which correspond to the main frames, by recording at least one of the main frames and the complementary frames, which correspond to the main frames, in a certain temporary recording unit.

5. An information display device comprising a display controller that performs processing to display stereoscopic video information integrated by the information integrating device according to claim 1.

6. An information recording device comprising a recording controller that performs processing to record stereoscopic video information integrated by the information integrating device according to claim 1 in a certain recording unit.

7. An information integrating method executed by an information integrating device that integrates main information including two-dimensional video content and complementary information for converting the two-dimensional video content to stereoscopic video as stereoscopic video information, comprising:
a main information receiving step of receiving the main information;
a complementary information receiving step of receiving the complementary information; and
an integrating step of integrating the main information, received in the main information receiving step, and the complementary information, received in the complementary information receiving step, as stereoscopic video information by using the main information and the complementary information.

8. An information integrating program for causing a computer to execute the steps of the information integrating method according to claim 7.

9. A computer-readable recording medium having recorded thereon the information integrating program according to claim 8.
